(19) United States
(12) Patent Application Publication
(10) Pub. No.: US 2014/0090504 A1
(43) Pub. Date: Apr. 3, 2014

(54) SHIFT LEVER FOR A VEHICLE WITH AN INTEGRATED OPERATING ELEMENT

(71) Applicant: GM GLOBAL TECHNOLOGY OPERATIONS LLC, Detroit, MI (US)

(72) Inventor: Johannes HUTH, Trebur (DE)

(73) Assignee: GM GLOBAL TECHNOLOGY OPERATIONS LLC, Detroit, MI (US)

(21) Appl. No.: 14/027,822

(22) Filed: Sep. 16, 2013

(30) Foreign Application Priority Data
Sep. 14, 2012 (DE) 10 2012 018 195.7

(51) Int. Cl. F16H 59/02

(52) U.S. Cl. CPC F16H 59/0217
USPC 74/473.19

(57) ABSTRACT

A shift lever for a vehicle with an integrated operating element for selecting and adjusting functions of the vehicle. The shift lever includes, but is not limited to a shift lever portion with the function of a shift lever knob has an operating element, which is pivot-moveably connected to a shift lever rod via a pivot joint, the pivot joint being designed for pivoting the shift lever knob relative to the shift lever rod in at least one pivot plane, and a sensor for generating a sensor signal which is dependent on the angular position of the shift lever knob in the pivot plane relative to the shift lever rod and which determines the selected function, is provided. A motor vehicle is also provided with this shift lever.

### CROSS-REFERENCE TO RELATED APPLICATION

This application claims priority to German Patent Application No. 10 2012 018 195.7, filed Sep. 14, 2012, which is incorporated herein by reference in its entirety.

### TECHNICAL FIELD

The technical field relates to a shift lever for a vehicle with an integrated operating element for selecting and adjusting functions of the vehicle.

### BACKGROUND

Shift levers serve as gearshift levers in vehicles, in particular motor vehicles, for both manual transmissions and for automatic transmissions. In DE 10 2007 022 086 A1 a shift lever knob of a shift lever is described, which with its first end region is fastened to a free end of a shift lever for actuating a transmission of a motor vehicle. In the shift lever knob, a receptacle that is open towards a second end region that is opposite the first end region is formed, in which an input unit with a touch-sensitive and/or approach-sensitive input surface is arranged. By this means, this shift lever knob of the shift lever can be used in dual function for actuating a transmission of the vehicle as well as for entering information. In order to make possible further operating applications, further operating elements, such as for example buttons can be arranged on the shift lever knob and/or on the shift lever.

DE 100 25 357 A1 describes a gearshift lever with a modular structure, such that customer-specifically configured operating modules with operating elements for switching vehicle functions or vehicle devices can be mounted on a standardized shift lever basic body. A connecting part of the operating module serves as a swivel bearing for the operating module, which in turn is designed as a swivel. Between the swivel and the shift lever basic body, a circuit board is arranged, which interacts with at least one contact element in such a manner that the respective integrated operating element is actuated through a relative turning movement between the shift lever basic body and the switch module.

In DE 10 2006 019 065 A1 a shift lever is described, which comprises a shift lever knob with a finger support surface, so that a sensing device an output signal is generated as a function of the position of a finger on the finger support surface. Here, this sensing device can be embodied as a track ball or in the manner of a touch pad.

Finally, a gearshift lever for a vehicle is also known from DE 20 2005 020 169 U1, in which a track ball that is rotatably mounted in the gearshift lever is integrated. Thus, a cursor of a display unit can be controlled with the track ball. Furthermore, a mouse button is realized with the track ball by pressing it and additional switching elements such as for example push buttons can be integrated in the gear shift lever, which when pressed trigger a function corresponding to the cursor position.

Increasingly, electronic devices such as comfort systems, multimedia systems, driver assistance systems or communication devices are employed in modern vehicles, the operation of that require more and more operating elements because of the multiplicity of integrated functions, which have to be arranged in a user-friendly ergonomic manner for the driver, while the operation of these functions takes place via a display or the head unit of an infotainment system.

In view of the foregoing, at least one object is creating a shift lever for a vehicle with an integrated operating element for selecting and adjusting function of the vehicle, which makes possible a safe and user-friendly possibility of operating menu-controlled devices through the vehicle occupants of the vehicle. In addition, other objects, desirable features and characteristics will become apparent from the subsequent summary and detailed description, and the appended claims, taken in conjunction with the accompanying drawings and this background.

### SUMMARY

Accordingly, a shift lever is provided for a vehicle with an integrated operating element for selecting and adjusting functions of the vehicle. The shift lever comprises a shift lever portion with the function of a shift lever knob as operating element, which is pivot-moveably connected to a shift lever rod via a pivot joint, the pivot joint being designed for pivoting the shift lever portion with the function of a shift lever knob relative to the shift lever rod in at least one pivot plane, and a sensor for generating a sensor signal that is dependent on the angular position of the shift lever portion with the function of a shift lever knob in the pivot plane relative to the shift lever rod which determines the selected function.

With such a shift lever, a secure navigation of a cursor on a display or a head unit or on an instrument cluster of the vehicle can be carried out, since the shift lever portion with the function of a shift lever knob can be operated similar to a joystick and compared with a track ball has the advantage that a better coordination of the movement of the cursor on the display is possible, since vibrations of the vehicle cannot be so easily transmitted to the hand of a user performing the movement of the joystick, which during the operation by means of a track ball cannot be excluded. Furthermore, a motor vehicle is provided with a shift lever.

A fixing element is provided in accordance with an embodiment, which is designed in a first position to make possible the pivoting of the shift lever portion with the function of a shift lever knob or the turning of the shift lever portion with the function of a shift lever knob in a turning plane relative to the shift lever rod and in a second position fix the shift lever portion with the function of a shift lever knob in a position that is predetermined relative to the shift lever rod. By doing so it is ensured that the actual function of the shift lever as gearshift lever is also possible, namely when in the second position the fixing element the shift lever rod and the shift lever portion with the function of a shift lever knob are rigidly connected to one another.

Thus, according to an embodiment, a fixing element, a connecting sleeve that is axially displaceable on the shift lever rod is provided, which is designed in the second position to enclose adjacent end regions of the shift lever rod and of the shift lever portion with the function of a shift lever knob in the predetermined position. A fixing element designed thus can be realized in a mechanically simple manner.

According to another embodiment, a connecting mandrel which has fixing elements is axially displaceable in the shift lever rod is provided, which is designed in the second position to rigidly connect the shift lever rod with the shift lever portion with the function of a shift lever knob in its predetermined position. This realization of a fixing element is not externally detectable and consequently results in a visually attractive design of the shift lever.

According to an embodiment, an operating switch is furthermore provided in the region of the shift lever portion with the function of a shift lever knob, which is designed to bring about a displacement of the fixing element from the first position into the second position when actuated. This makes it possible with automatic transmissions, through an actuation of this operating switch by the driver of the vehicle, to use the shift lever in the function of a transmission selector lever, i.e., with actuated operating switch, the shift lever can be used in its function as transmission selector lever. This ensures a simple operating change between the two functions of the shift lever. Of course, this is also possible with shift levers for a manual transmission. Additionally or alternatively it can also be provided that the operating switch is formed in the region of the clutch of a vehicle equipped with a manual transmission.

In order to emulate a complete joystick function of the shift lever, it is advantageous to design the pivot joint or pivoting the shift lever portion with the function of a shift lever knob in two pivot planes and/or for turning the shift lever portion with the function of a shift lever knob in a plane defined by the two pivot planes, i.e., the pivot joint has at least two degrees of freedom.

Designing the pivot joint as a ball joint according to an embodiment, results in a haptically pleasant actuation feeling. Here, the shift lever portion with the function of a shift lever knob comprises a joint ball forming the ball joint, which joint ball is received by a spherical shell formed in the shift lever rod. Preferentially, the joint ball is connected to the shift lever portion with the function of a shift lever knob via a ball pin. The spherical shell of the shift lever rod is designed to enclose the joint ball including the ball pin.

This configuration of the ball joint allows an optimal placement of a sensor with at least one pressure sensor is arranged in the region of the spherical shell enclosing the ball pin. With such pressure sensors, the pivot angle of the shift lever portion with the function of a shift lever knob relative to the shift lever rod can be analogously sensed. In order to be able to also adjust or activate, in particular in a comfortable manner in the joystick function of the shift lever for example the function selected on a display, a selector operating switch is arranged according to an embodiment on the shift lever portion with the function of a shift lever knob.

If practical, the above configurations embodiments can be combined as desired. Further possible configurations, further developments and implementations of the invention also include combinations of features of the invention described before or in the following with respect to the exemplary embodiments that have not been explicitly mentioned. In particular, the person skilled in the art will also add individual aspects as improvements or additions to the respective basic form.

### BRIEF DESCRIPTION OF THE DRAWINGS

The present invention will hereinafter be described in conjunction with the following drawing figures, wherein like numerals denote like elements, and:

FIG. 1a, FIG. 1b, and FIG. 1c are schematic sectional representations of a shift lever in its function as a joystick in different positions of the shift lever portion with the function of a shift lever knob as an embodiment;

FIG. 2 is a schematic representation of a top view of the shift lever portion with the function of a shift lever knob of the shift lever according to FIG. 1;

FIG. 3a and FIG. 3b are schematic representations of a lateral and top view of a fixing element designed as a connecting sleeve;

FIG. 4 is a schematic representation of the shift lever according to FIG. 1 with a fixing element according to FIG. 3 in a position I;

FIG. 5 is a schematic sectional representation of the shift lever according to FIG. 4, in the case of which the shift lever portion with the function of a shift lever knob is fixed in a position II relative to the shift lever rod by means of a connecting sleeve as fixing sleeve;

FIG. 6 is a schematic sectional representation of the shift lever according to FIG. 1 with a connecting mandrel as fixing element in a position I; and

FIG. 7 is a schematic representation of the shift lever according to FIG. 6, in which the shift lever portion with the function of a shift lever knob is fixed in a position II relative to the shift lever rod by means of the connecting mandrel.

### DETAILED DESCRIPTION

The following detailed description is merely exemplary in nature and is not intended to limit application and uses. Furthermore, there is no intention to be bound by any theory presented in the preceding background or summary or the following detailed description.

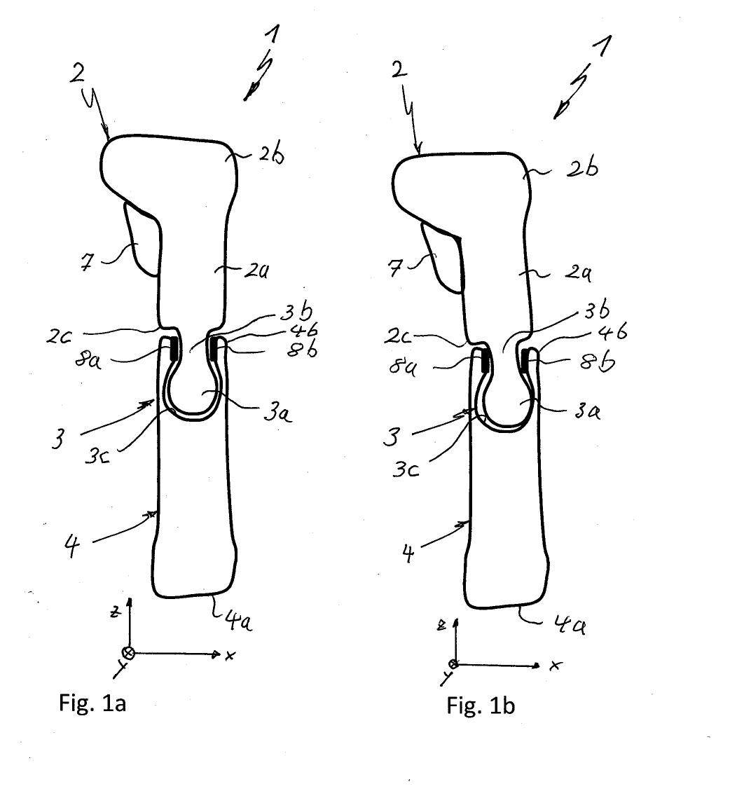

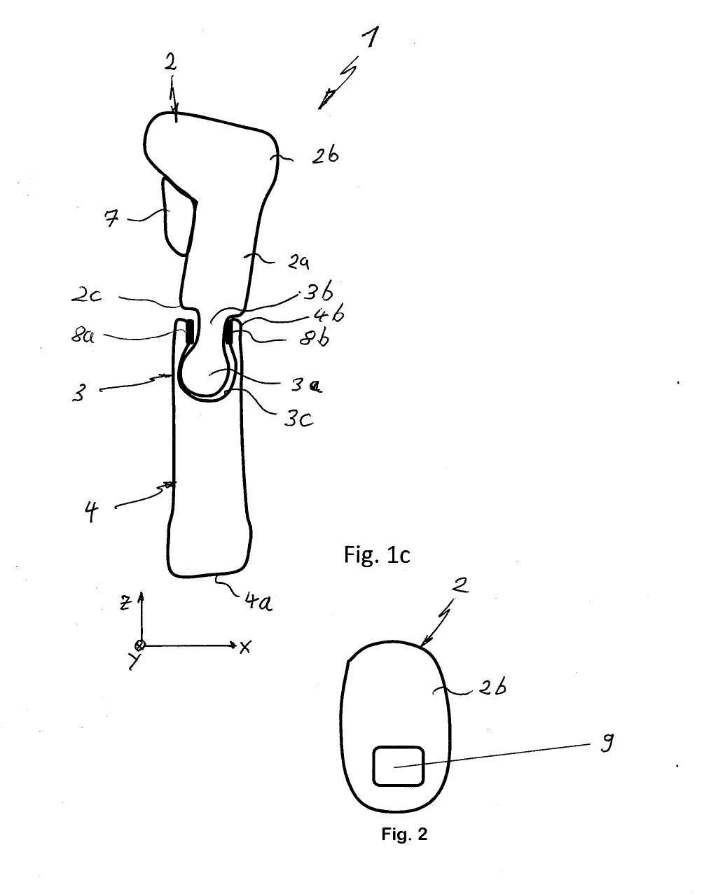

FIG. 1 shows a schematic sectional representation of a shift lever in its function as a joystick in different positions of the shift lever portion with the function of a shift lever knob as an embodiment. The shift lever 1 shown in the FIG. 1a to FIG. 1c serves as a gearshift lever of a manual transmission or of an automatic transmission of a vehicle, in particular of a motor vehicle. Such a gearshift lever is operated by the driver of the vehicle.

This shift lever 1 is composed of a shift lever rod 4 and a shift lever portion with the function of a shift lever knob 2 that is connected with said shift lever rod 4 via a ball joint 3. The shift lever portion with the function of a shift lever knob 2 on the shift lever rod side comprises a shift lever knob rod 2a and a knob head 2b following thereon.

The free end 4a of the shift lever rod 4 projects into a control console (not shown), in which the shift lever rod 4 is articulated, so that with the shift lever 1 different transmission control positions can be adjusted. On the opposite end 4b of the shift lever rod 4 is located a spherical shell 3c for receiving a joint ball 3a for forming the ball joint 3. The joint ball 3a is connected to the shift lever knob rod 2a via a ball pin 3b. The end region 4b of the shift lever rod 4 is designed such that not only the joint ball 3a but partially also the ball pin 3b is enclosed. With the two degrees of freedom of the ball joint 3, the shift lever portion with the function of a shift lever knob 2 can be tilted in two planes, i.e., in the x-z and in the y-z plane relative to the shift lever rod 4 from a 0-position, in which according to FIG. 1a the shift lever rod 4 is aligned with the shift lever portion with the function of a shift lever knob 2, i.e., with its shift lever knob rod 2a, in the manner of a joystick.

For detecting the tilting angle in the x-z plane, a sensor is provided, which as pressure sensors 8a and 8b are arranged in the end region 4b of the shift lever rod 4 at the height of the ball pin 3b, so that upon a tilting movement of the shift lever portion with the function of a shift lever knob 2 in a pivot plane located in the x-z plane, one of the two pressure sensors each 8a or 8b is pressure-loaded, as is shown in the FIG. 1b and FIG. 1c.

In order to be likewise able to detect a tilting movement of the shift lever portion with the function of a shift lever knob 2 in a pivot plane located in the y-z plane, two further pressure sensors (not shown) that are arranged offset by approximately 90° are provided, which together with the pressure sensors 8a and 8b are arranged on the inner surface of the spherical shell 3c so that these rim the ball pin 3b in a ring-like manner.

As a function of the tilting angle of the shift lever portion with the function of a shift lever knob 2 relative to the shift lever rod 4, an angle-proportional sensor signal, i.e., an electrical signal is generated by the respective pressure sensor thus pressure-loaded, which electric signal is converted by an evaluation unit into a corresponding control signal for a cursor on a display unit, for example a display.

Thus, a driver of the vehicle can control a cursor on a display by handling the shift lever portion with the function of a shift lever knob 2 in the manner of a joystick in order to, for example, select a certain function from a menu. Activating these selected functions is performed by means of a selector operating switch 9, which is arranged on the top of the knob head 2b according to FIG. 2 and is designed as a push button corresponding to a “mouse” button.

In order to be able to use the fifth lever 1 in addition to its function as a joystick also in its actual function as a gear selector lever for a manual transmission or an automatic transmission it has to be ensured that in this function the shift lever portion with the function of a shift lever knob 2 remains fixed in a predetermined position relative to the shift lever rod 4, i.e., in the 0-position according to FIG. 1a. A fixing element serves for this purpose.

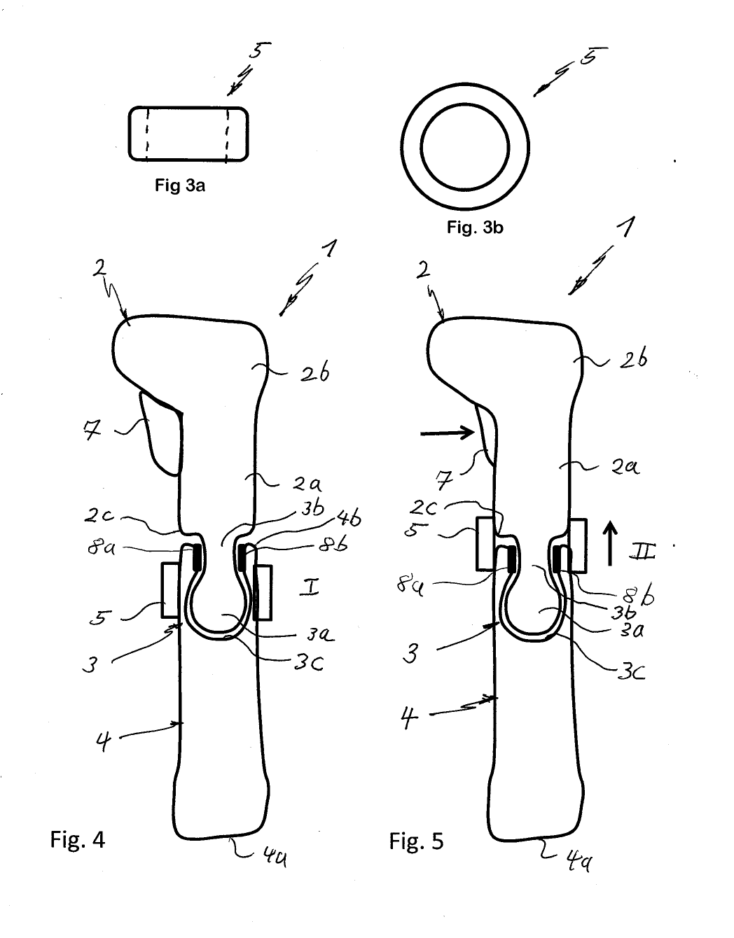

In a first embodiment, this fixing element according to the FIG. 3a and FIG. 3b is designed as a connecting sleeve 5, which according to FIG. 4 is arranged according to FIG. 4 in the end region 4b of the shift lever rod 4 displaceably on the latter, i.e., the inner diameter of the connecting sleeve 5 substantially corresponds to the outer diameter of the shift lever rod 4 in its end region 4b. When the 0-position of the shift lever portion with the function of a shift lever knob 2 is now to be fixed, the connecting sleeve 5 is displaced from a position II according to FIG. 4 in the direction of the shift lever portion with the function of a shift lever knob 2 until the end region 2c of the shift lever knob rod 2a in a position II is also enclosed by the connecting sleeve 5, as is evident from FIG. 5. In this position II according to FIG. 5, the end regions 4b and 2c of the shift lever rod 4 or of the shift lever knob rod 2a are simultaneously enclosed by this connecting sleeve 5, so that the position of the shift lever portion with the function of a shift lever knob 2 is fixed relative to the shift lever rod 4.

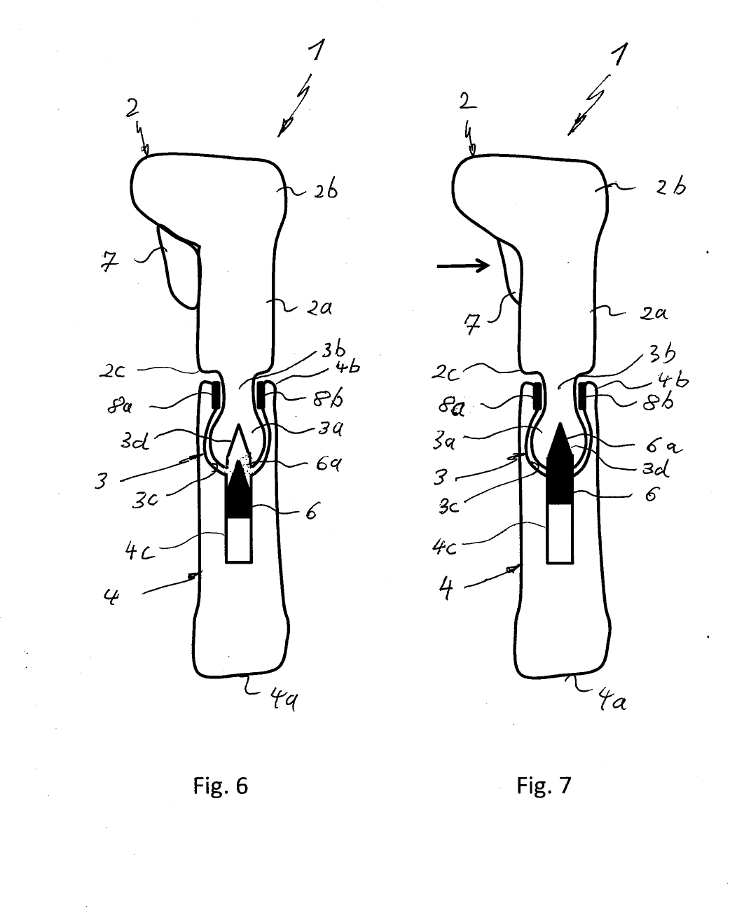

A further embodiment of a fixing element is shown in FIG. 6, according to which a connecting mandrel 6 in a mandrel guide bore 4c of the shift lever rod 4 is concentrically and displaceably mounted in the latter. This mandrel guide bore 4c is continued in a mandrel mounting 3d of the joint ball 3a of the shift lever portion with the function of a shift lever knob 2, so that the connecting mandrel 6 can be displaced out of a position I according to FIG. 6 in the direction of the joint ball 3a, so that it connects the mandrel by bore 4c with the mandrel mounting 3d in a position II according to FIG. 7 and because of this the fixing of the shift lever portion with the function of a shift lever knob 2 relative to the shift lever rod 4 in the 0-position is achieved.

The connecting mandrel 6 is provided with a conical tip 6a on the joint head side, so that this tip 6a in the position II of the connecting mandrel 6 engages in the mandrel mounting 3d suitably formed on the end side in a surface-joined manner, as a result of which a centering of the shift lever portion with the function of a shift lever knob 2 in its 0-position, in particular from a tilting position is achieved. When the shift lever 1 constitutes a gearshift lever of an automatic transmission, an operating switch 7 is provided in the region of the transition of the shift lever knob rod 2a to the knob head 2b for carrying out a transmission function, which on actuation initiates the displacement of the fixing element, i.e., of the connecting sleeve 5 or of the connecting mandrel 6 from its position I into its position II. Following the actuation of this operating switch 7, the connecting sleeve 5 or the connecting mandrel 6 returns to its position I again.

In the case of a manual transmission, the connecting sleeve 5 or the connecting mandrel 6 is functionally coupled to the operation of actuating a clutch of the vehicle, so that upon an actuation of the clutch, the connecting sleeve 5 or the connecting mandrel 6 is automatically displaced from its position I into its position II. Following the actuation of the clutch, the connecting sleeve 5 or the connecting mandrel 6 is again displaced back into its position I.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an embodiment, it being understood that various changes may be made in the function and arrangement of elements described in an embodiment without departing from the scope as set forth in the appended claims and their legal equivalents.

1. A shift lever for a vehicle with an integrated operating element for selecting and adjusting a function of the vehicle, comprising:
a shift lever portion with the function of a shift lever knob as operating element;
a shift lever rod pivot-moveably connected to the shift lever portion via a pivot joint, wherein the pivot joint is configured to pivot the shift lever portion with the function of a shift lever knob relative to the shift lever rod in pivot plane; and
a sensor that is configured to generate a sensor signal that is at least partially dependent on an angle position of the shift lever portion with the function of the shift lever knob in the pivot plane relative to the shift lever rod, and that determines a selected function.

2. The shift lever according to claim 1, further comprising a fixing element having a first position that provides a pivoting of the shift lever portion with the function of the shift lever knob relative to the shift lever rod and in a second position fix the shift lever portion with the function of the shift lever knob in a second position that is predetermined relative to the shift lever rod.

3. The shift lever according to claim 2, further comprising a connecting sleeve a the fixing element that is axially displaceable on the shift lever rod, which is configured to enclose in the second position at adjacent end regions of the shift lever rod and of the shift lever portion with the function of the shift lever knob in a predetermined position.

4. The shift lever according to claim 2, further comprising a connecting mandrel as the fixing element that is axially displaceable in the shift lever rod, which configured to rigidly connect in the second position the shift lever rod to the shift lever portion with the function of the shift lever knob in a predetermined position.

5. The shift lever according to claim 2, further comprising an operating switch in a region of the shift lever portion with the function of the shift lever knob that is configured upon actuation to bring about a displacement of the fixing element from the first position into the second position.

6. The shift lever according to claim 1, wherein the pivot joint is configured to pivot the shift lever portion with the function of the shift lever knob in two pivot planes.

7. The shift lever according to claim 1, wherein the pivot joint is a ball joint.

8. The shift lever according to claim 7, wherein the shift lever portion with the function of the shift lever knob forming the ball joint comprises a joint ball that is received by a spherical shell formed in the shift lever rod.

9. The shift lever according to claim 8,
wherein the joint ball is connected via a ball pin to the shift lever portion with the function of the shift lever knob; and
wherein the spherical shell of the shift lever rod is configured to enclose the joint ball and the ball pin.

10. The shift lever according to claim 9, wherein the sensor is arranged in a region of the spherical shell enclosing the ball pin.

11. The shift lever claim 1, further comprising a selector operating switch arranged on the shift lever portion with the function of the shift lever knob that is configured to carrying out a switching function with respect to the selected function.

12. (canceled)
